(19) United States
(12) Patent Application Publication
(10) Pub. No.: US 2025/0070312 A1
(43) Pub. Date: Feb. 27, 2025

(54) ENERGY STORAGE APPARATUS AND THERMAL MANAGEMENT CONTROL METHOD

(71) Applicant: Jinko Energy Storage Technology Co., Ltd., Haining City (CN)

(72) Inventor: Junyun WEN, Haining City (CN)

(21) Appl. No.: 18/946,305

(22) Filed: Nov. 13, 2024

(30) Foreign Application Priority Data
May 13, 2024 (CN) 202410593201.0

(51) Int. Cl. H01M 10/6566; H01M 10/613; H01M 10/615; H01M 10/627; H01M 10/633; H01M 10/635; H01M 10/6556; H01M 10/6563; H01M 50/289

(52) U.S. Cl. CPC H01M 10/6566; H01M 10/613; H01M 10/615; H01M 10/627; H01M 10/633; H01M 10/635; H01M 10/6556; H01M 10/6563; H01M 50/289

(57) ABSTRACT

An energy storage apparatus includes: a box. The box includes: a battery compartment and a device compartment. The battery compartment is provided with a separation portion. The separation portion divides the battery compartment into an upper compartment and a lower compartment. The separation portion is provided with a communication hole. The communication hole is in communication with the upper compartment and the lower compartment. The device compartment is provided with an air conditioner. A first side wall is provided between the battery compartment and the device compartment. The first side wall is provided with an inlet and an outlet. One of the inlet and the outlet is in communication with the upper compartment, and the other is in communication with the lower compartment. Baffles are provided at the inlet and the outlet. The baffles are capable of opening or closing the inlet and the outlet.

### CROSS-REFERENCE TO RELATED APPLICATIONS

This application claims priority to Chinese Patent Application No. 2024105932010, filed on May 13, 2024, entitled “ENERGY STORAGE APPARATUS AND THERMAL MANAGEMENT CONTROL METHOD”, the content of which is hereby incorporated by reference in its entirety.

### TECHNICAL FIELD

The present disclosure relates to the technical field of energy storage, and in particular, to an energy storage apparatus and a thermal management control method.

### BACKGROUND

Photovoltaic energy storage converts solar energy into electrical energy for storage. The storage of the electrical energy is achieved through an energy storage system. The energy storage system includes a battery compartment. A battery pack is placed in the battery compartment. During charging and discharging of the battery pack, a temperature of the battery pack may rise. If the temperature of the battery pack is excessively high, operating efficiency of the battery pack may be affected, and spontaneous combustion of the battery pack may also be caused. If the temperature of the battery pack is excessively low, the operating efficiency of the battery pack may also be affected, and even the battery pack is damaged.

### SUMMARY

Embodiments of the present disclosure provide an energy storage apparatus, including: a box. The box includes: a battery compartment and a device compartment. The battery compartment is provided with a separation portion. The separation portion divides the battery compartment into an upper compartment and a lower compartment. The separation portion is provided with a communication hole. The communication hole is in communication with the upper compartment and the lower compartment. The device compartment is provided with an air conditioner. A first side wall is provided between the battery compartment and the device compartment. The first side wall is provided with an inlet and an outlet. One of the inlet and the outlet is in communication with the upper compartment, and the other of the inlet and the outlet is in communication with the lower compartment. Baffles are provided at the inlet and the outlet. The baffles are capable of opening or closing the inlet and the outlet.

In one embodiment, at least one of the inlet, the outlet, and the communication hole is provided with a drive component, and the drive component is configured to drive air to flow unidirectionally.

In one embodiment, along a length direction of the box, a plurality of battery compartments are provided, adjacent battery compartments being in communication with each other, and each of the battery compartments is provided with the separation portion; and along the length direction of the box, the communication hole is provided in the separation portion farthest from the device compartment.

In one embodiment, along the length direction of the box, the battery compartment farthest from the device compartment has a second side wall, and a deflector is provided on a side of the second side wall facing the first side wall; and in a direction from the first side wall to the second side wall, the deflector is inclined towards the communication hole.

In one embodiment, each of the battery compartments is provided with a mounting rack, and the separation portion is mounted on the mounting rack.

In one embodiment, along a height direction of the box, the separation portion is provided at a middle position of the battery compartment.

Embodiments of the present disclosure provide a thermal management control method applied to the energy storage apparatus the above, and the thermal management control method includes:
acquiring an ambient temperature T in the battery compartment;
determining whether the ambient temperature T is higher than or equal to a first preset temperature T1;
if the ambient temperature T is higher than or equal to the first preset temperature T1, controlling the baffles to open the inlet and the outlet, and controlling the air conditioner to be turned on;
if the ambient temperature T is lower than the first preset temperature T1, continuously determining whether the ambient temperature T is lower than or equal to a second preset temperature T2; and
if the ambient temperature T is lower than or equal to the second preset temperature T2, controlling the baffles to open the inlet and the outlet, and controlling the air conditioner to be turned off.

In one embodiment, when it is determined that the ambient temperature T is lower than the first preset temperature T1 and higher than the second preset temperature T2, the thermal management control method further includes:
acquiring an ambient humidity RH0 in the battery compartment, and calculating standard humidity RH1 according to the ambient temperature T;
determining whether the ambient humidity RH0 in the battery compartment is less than or equal to first preset humidity RH1;
if the ambient humidity RH0 in the battery compartment is less than or equal to the first preset humidity RH1, controlling the baffles to close the inlet and the outlet, controlling the air conditioner to be turned on, and controlling a battery pack in the battery compartment to operate; and
if the ambient humidity RH0 in the battery compartment is greater than the first preset humidity RH1, controlling the baffles to open the inlet and the outlet, and controlling the air conditioner to be turned on.

In one embodiment, the standard humidity RH1 is a humidity corresponding to the ambient temperature T being a dew point temperature minus a preset value x.

In one embodiment, at least one of the inlet, the outlet, and the communication hole is provided with a drive component;
after the step of controlling the baffles to open the inlet and the outlet, the thermal management control method further includes: controlling the drive component to operate; and
after the step of controlling the baffles to close the inlet and the outlet, the thermal management control method further includes: controlling the drive component to stop operating.

In the present disclosure, when the baffles open the inlet and the outlet in the first side wall, air in the device compartment can flow into the battery compartment through the inlet, air in the upper compartment and the lower compartment can circulate through the communication hole, and air in the battery compartment can flow back to the device compartment through the outlet, thereby realizing circulation and exchange of the air in the battery compartment and the device compartment, so that the air conditioner in the device compartment can cool down the battery compartment, or heat generated by operation of the device in the device compartment can heat up the battery compartment to adjust the temperature in the battery compartment, enabling a battery pack to operate at an appropriate temperature.

It should be understood that the general description above and the detailed description in the following are merely exemplary, and cannot limit the present disclosure.

### BRIEF DESCRIPTION OF THE DRAWINGS

FIG. 1 is a perspective view of an energy storage apparatus according to the present disclosure;

FIG. 2 is a perspective view of a box of the energy storage apparatus according to a specific embodiment of the present disclosure;

FIG. 3 is a schematic diagram of the box in FIG. 2; and

FIG. 4 is a flowchart of a thermal management control method according to an embodiment of the present disclosure.

### DETAILED DESCRIPTION

In order to better understand the technical solution of the present disclosure, embodiments of the present disclosure will be described in detail below with reference to the accompanying drawings.

It should be clear that the described embodiments are only some of rather than all of the embodiments of the present disclosure. Based on the embodiments in the present disclosure, all other embodiments obtained by those of ordinary skill in the art without creative efforts fall within the protection scope of the present disclosure.

The terms used in the embodiments of the present disclosure are only for the purpose of describing specific embodiments and are not intended to limit the present disclosure. As used in the embodiments of the present disclosure and the appended claims, the singular forms of “a/an”, “one”, and “the” are intended to include plural forms, unless otherwise clearly specified in the context.

It should be understood that the term “and/or” describes an association relationship between associated objects and represents that three relationships may exist. For example, A and/or B may represent the following three cases: only A exists, both A and B exist, and only B exists. In addition, the character “/” generally indicates an “or” relationship between the associated objects.

It should be noted that orientation terms such as “upper”, “lower”, “left”, and “right” described in the embodiments of the present disclosure are described from the perspective shown in the drawings and should not be understood as limiting the embodiments of the present disclosure. Additionally, it should be understood in the context that when an element is referred to as being connected “on” or “under” another element, the element can not only be directly connected “on” or “under” the another element, but also can be directly connected “on” or “under” the another element, or may be indirectly connected “on” or “under” the another element through an intermediate element.

An energy storage apparatus is featured with simplified infrastructure construction costs, a short construction cycle, a high degree of modularity, easy transportation, and mounting, and can be applied to thermal, wind, solar and other power stations or in applications such as islands, communities, schools, scientific research institutions, factories, and large load centers.

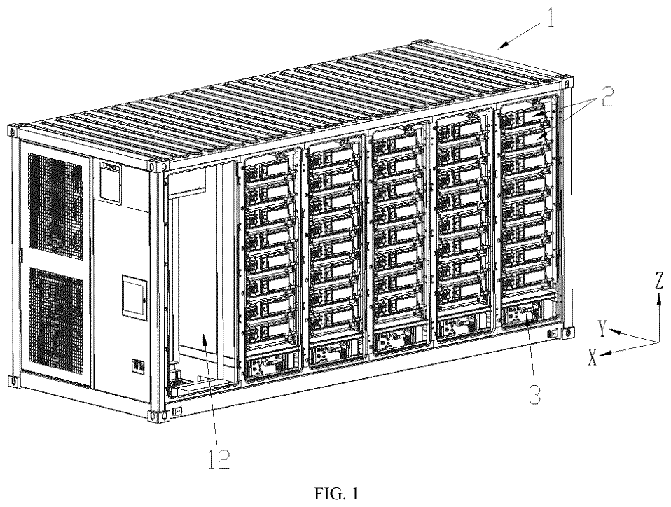

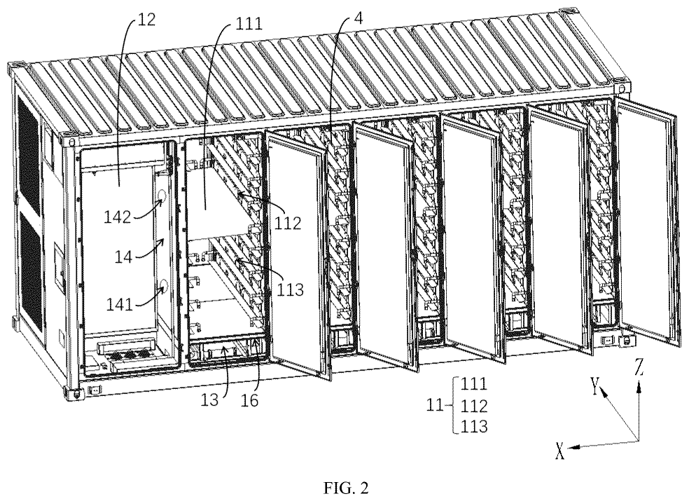

As shown in FIG. 1 and FIG. 2, the energy storage apparatus includes a box 1. The box 1 includes: a battery compartment 11, a device compartment 12, and a high-voltage compartment 13, a mounting rack 4 is placed in the battery compartment 11, and a battery pack 2 is placed on the mounting rack 4. A power conversion system, an energy management system control cabinet, and other related devices are placed in the device compartment 12. The power conversion system may control charging and discharging processes, converting AC to DC, and can directly power AC loads when there is no power grid. The energy management system control cabinet mainly collects states of real-time power of a power grid through communication with smart meters and detects changes in load power in real time. A high-voltage box 3 is placed in the high-voltage compartment 13. The high-voltage box 3 has a high-voltage circuit management module configured to connect the battery pack 2 and the power conversion system. The high-voltage circuit management module has functions such as collecting a voltage and a current of the battery pack 2 and controlling and protecting a contactor. The high-voltage compartment 13 is located at the bottom or top of the battery compartment 11. The high-voltage compartment 13 and the battery compartment 11 are separated by a partition 16, so as to facilitate wiring between the battery pack 2 and the high-voltage box 3.

In order to facilitate the description of the structure of the energy storage device, the box 1 has a length direction X, a width direction Y, and a height direction Z. The length direction X, the width direction Y, and the height direction Z are perpendicular to one another.

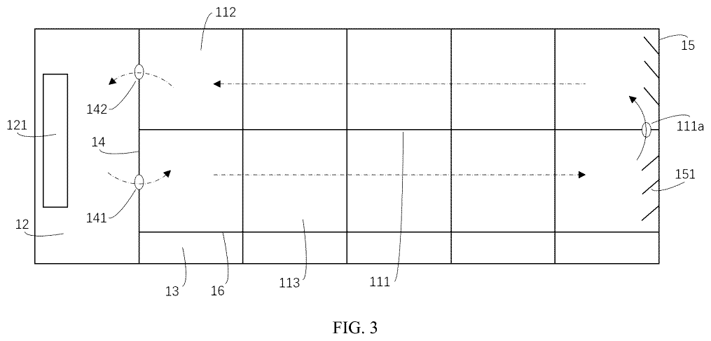

In the embodiment of the present disclosure, as shown in FIG. 2 and FIG. 3, the battery compartment 11 is provided with a separation portion 111, and the separation portion 111 divides the battery compartment 11 into an upper compartment 112 and a lower compartment 113. The separation portion 111 is provided with a communication hole 111a, and the communication hole 111a is in communication with the upper compartment 112 and the lower compartment 113. The device compartment 12 is provided with an air conditioner 121. A first side wall 14 is provided between the battery compartment 11 and the device compartment 12. The first side wall 14 is provided with an inlet 141 and an outlet 142. One of the inlet 141 and the outlet 142 is in communication with the upper compartment 112, and the other is in communication with the lower compartment 113. Baffles are provided at the inlet 141 and the outlet 142, and the baffles can open or close the inlet 141 and the outlet 142.

In this embodiment, as shown in FIG. 2 and FIG. 3, when the baffles open the inlet 141 and the outlet 142 in the first side wall 14, air in the device compartment 12 can flow into the battery compartment 11 through the inlet 141. Air in the upper compartment 112 and the lower compartment 113 can circulate through the communication hole 111a, and air in the battery compartment 11 can flow back to the device compartment 12 through the outlet 142, thereby realizing circulation and exchange of the air in the battery compartment 11 and the device compartment 12. Therefore, the air conditioner 121 in the device compartment 12 can cool down the battery compartment 11, or heat generated by operation of the device in the device compartment 12 can heat up the battery compartment 11, so as to adjust the temperature in the battery compartment 11, thereby enabling the battery pack 2 to operate at an appropriate temperature.

Specifically, as shown in FIG. 3, the inlet 141 in the first side wall 14 may be in communication with the lower compartment 113, and the outlet 142 in the first side wall 14 may be in communication with the upper compartment 112. In this case, an air circulation path in the battery compartment 11 and the device compartment 12 is as follows: air in the device compartment 12 flows into the lower compartment 113 through the inlet 141, air in the lower compartment 113 flows into the upper compartment 112 through the communication hole 111a, and air in the upper compartment 112 flows back to the device compartment 12 through the outlet 142 (a dashed line segment with arrows in FIG. 3 shows a flow path of air). It should be understood that, alternatively, the inlet 141 in the first side wall 14 may be in communication with the upper compartment 112, and the outlet 142 in the first side wall 14 may be in communication with the lower compartment 113. In this case, the air circulation path in the battery compartment 11 and the device compartment 12 is as follows: the air in the device compartment 12 flows into the upper compartment 112 through the inlet 141, the air in the upper compartment 112 flows into the lower compartment 113 through the communication hole 111a, and the air in the lower compartment 113 flows back to the device compartment 12 through the outlet 142. For the convenience of description, the following takes the air circulation path in the battery compartment 11 and the device compartment 12 in FIG. 3 as an example.

More specifically, as shown in FIG. 2 and FIG. 3, along a length direction X of the box 1, a plurality of battery compartments 11 are provided. Adjacent two battery compartments 11 are in communication with each other, and each of the battery compartments 11 is provided with the separation portion 111. A mounting rack 4 is placed in the battery compartment 11. The air can flow in adjacent battery compartments 11 through gaps on the mounting rack 4. Since each battery compartment 11 is provided with the separation portion 111, the upper compartment 112 of adjacent battery compartments 11 are in communication with each other, and the lower compartments 113 of adjacent battery compartments 11 are in communication with each other.

Along the length direction X of the box 1, the communication hole 111a is provided in the separation portion 111 farthest from the device compartment 12, so that the air entering the lower compartment 113 from the inlet 141 can flow through the upper compartment 112 and the lower compartment 113 of all the battery compartments 11 and then return to the device compartment 12. Air circulation in the battery compartment 11 and the device compartment 12 is more complete and thorough, which has a better effect on the adjustment of the temperature of the battery compartment 11.

The separation portion 111 may be a plate-shaped component. When mounted in the battery compartment 11, the separation portion 111 may be directly supported by the mounting rack 4, thereby facilitating mounting of the separation portion 111 and improving mounting efficiency of the separation portion 111. It should be understood that the separation portion 111 may be connected to the mounting rack 4 by bonding, snapping, or screw connection to improve reliability of the connection between the two.

Further, at least one of the inlet 141, the outlet 142, and the communication hole 111a is provided with a drive component, and the drive component is configured to drive the air to flow unidirectionally, so that the air in the device compartment 12 can only enter the lower compartment 113 through the inlet 141, the air in the lower compartment 113 can only flow into the upper compartment 112 through the communication hole 111a, and the air in the upper compartment 112 can only flow into the device compartment 12 through the outlet 142, thereby realizing unidirectional circulation of air in the battery compartment 11 and the device compartment 12 and ensuring a temperature adjustment effect and efficiency of the battery compartment 11. Specifically, a shape of the communication hole 111a matches the drive component, so that the drive component can be mounted in the communication hole 111a. For example, the communication hole 111a may be in the shape of a circle, a rectangle, or the like. The drive component may be a fan or the like.

Furthermore, as shown in FIG. 3, along the length direction of the box 1, the battery compartment 11 farthest from the device compartment 12 has a second side wall 15, and a deflector 151 is provided on a side of the second side wall 15 facing the first side wall 14. The deflector 151 can guide the flow of the air, thereby accelerating air circulation in the battery compartment 11 and the device compartment 12.

Specifically, in a direction from the first side wall 14 to the second side wall 15, the deflector 151 is inclined towards the communication hole 111a, so that the deflector 151 can guide the flow of the air in the lower compartment 113 to the communication hole 11a, and guide the air flowing out from the communication hole 111a to the upper compartment 112, thereby effectively accelerating the flow of the air in the battery compartment 11.

More specifically, an angle between the deflector 151 and a horizontal direction is in a range of 5° to 85°, so as to ensure a guide effect of the deflector 151. For example, the angle between the deflector 151 and the horizontal direction is 20°, 30°, 40°, 45°, 50°, 60°, 70°, or the like. Preferably, the angle between the deflector 151 and the horizontal direction is 45°.

In a specific embodiment, as shown in FIG. 2 and FIG. 3, along a height direction Z of the box 1, the separation portion 111 is provided at a middle position of the battery compartment 11, so that volumes of the upper compartment 112 and the lower compartment 113 are similar and the air flows between the upper compartment 112 and the lower compartment 113 more smoothly. It should be understood that along the height direction Z of the box 1, the separation portion 111 may alternatively be provided at an upper or lower middle position of the battery compartment 11.

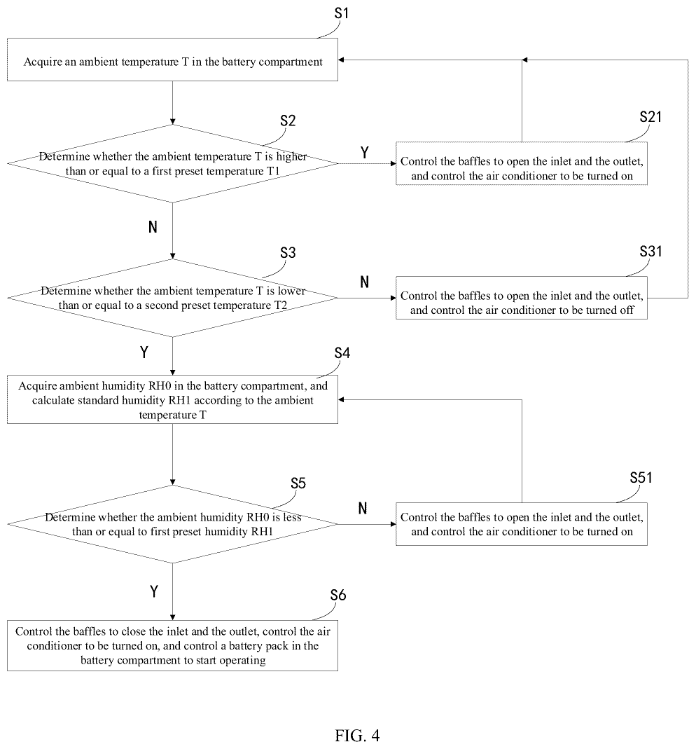

An embodiment of the present disclosure further provides a thermal management control method. The thermal management control method is applied to the energy storage apparatus provided in any of aforementioned embodiments. As shown in FIG. 4, the thermal management control method includes the following steps.

In step S1, an ambient temperature T in the battery compartment 11 is acquired.

In this step, the ambient temperature T in the battery compartment 11 can be acquired in real time by providing a temperature sensor in the battery compartment 11.

In step S2, it is determined whether the ambient temperature T is higher than or equal to a first preset temperature T1.

In this step, the device in the device compartment 12 may be provided with a control component, and the control component can receive the ambient temperature T and perform an operation of comparing the ambient temperature T with the first preset temperature T1.

If the ambient temperature T is higher than or equal to the first preset temperature T1, step S21 of controlling the baffles to open the inlet 141 and the outlet 142 and controlling the air conditioner 121 to be turned on is performed.

In this step, the ambient temperature T is higher than or equal to the first preset temperature T1, that is, the temperature inside the battery compartment 11 is higher and is not suitable for the battery pack 2 to operate. In this case, the inlet 141 and the outlet 142 are opened so that cold air generated by the air conditioner 121 can flow into the battery compartment 11 through the inlet 141 to cool down the battery compartment 11, and then flow back to the device compartment 12 through the outlet 142 to form a circular flow of air, thus achieving a better cooling effect on the battery compartment 11. At the same time, the air conditioner 121 can cool down the battery compartment 11 and can also reduce humidity in the battery compartment 11.

If the ambient temperature T is lower than the first preset temperature T1, step S3 of continuously determining whether the ambient temperature T is lower than or equal to a second preset temperature T2 is performed.

In this step, an operation of comparing the ambient temperature T with the second preset temperature T2 is also performed by the control component.

If the ambient temperature T is lower than or equal to the second preset temperature T2, step S31 of controlling the baffles to open the inlet 141 and the outlet 142 and controlling the air conditioner 121 to be turned off is performed.

In this step, the ambient temperature T is lower than or equal to the second preset temperature T2, that is, the temperature inside the battery compartment 11 is lower and is not suitable for the battery pack 2 to operate. In this case, the inlet 141 and the outlet 142 are opened so that air heated by heat generated by the device in the device compartment 12 can flow into the battery compartment 11 through the inlet 141 to heat the battery compartment 11, and then flow back to the device compartment 12 through the outlet 142 to form a circular flow of air, causing the temperature of the battery compartment 11 to rise.

In this embodiment, as shown in FIG. 4, the air is circulated in the device compartment 12 and the battery compartment 11 to adjust the temperature in the battery compartment 11, so that when the temperature in the battery compartment 11 is within a temperature range suitable for operation of the battery pack 2, the battery pack 2 is controlled to operate. Therefore, operating efficiency of the battery pack 2 is increased, the battery pack 2 has less loss, and the service life of the battery pack 2 is prolonged.

In addition, after step S21 of controlling the baffles to open the inlet 141 and the outlet 142 and controlling the air conditioner 121 to be turned on and step S31 of controlling the baffles to open the inlet 141 and the outlet 142 and controlling the air conditioner 121 to be turned off are performed at a fixed time interval, step S1 of acquiring an ambient temperature T in the battery compartment 11 is performed, to perform the operation in a loop until the ambient temperature T is between the first preset temperature T1 and the second preset temperature T2.

Specifically, a liquid cooling plate is provided below the battery pack 2. During charging and discharging of the battery pack 2, the temperature of the battery pack 2 may rise. The liquid cooling plate can cool down the battery pack 2, thus preventing an excessively high temperature of the battery pack 2. In the case of a low outside temperature, a coolant at a higher temperature may also be passed into the liquid cooling plate to heat the battery pack 2 and prevent damage to the battery pack 2 at an extremely cold temperature.

More specifically, the temperature range suitable for operation of the battery pack 2 generally ranges from 20° C. to 35° C. Since the battery pack 2 may also generate heat during operation, the first preset temperature T1 should be selected in a range of 25° C. to 30° C., preferably 25° C., and the second preset temperature T2 should be selected in a range of 20° C. to 25° C., preferably 20° C. It should be understood that the first preset temperature T1 and the second preset temperature T2 may be adjusted according to an actual condition and experience.

Further, as shown in FIG. 4, when it is determined that the ambient temperature T is lower than the first preset temperature T1 and higher than the second preset temperature T2, the thermal management control method further includes the following steps.

In step S4, ambient humidity RH0 in the battery compartment 11 is acquired, and standard humidity RH1 is calculated according to the ambient temperature T.

In this step, the ambient humidity RH0 in the battery compartment 11 can be acquired in real time by providing a humidity sensor in the battery compartment 11. The standard humidity RH1 is humidity at which water vapor in the air does not easily condense at the ambient temperature T.

In step S5, it is determined whether the ambient humidity RH0 in the battery compartment 11 is less than or equal to first preset humidity RH1.

In this step, an operation of comparing the ambient humidity RH0 with the first preset humidity RH1 is performed by the control component.

If the ambient humidity RH0 in the battery compartment 11 is greater than the first preset humidity RH1, S51 of controlling the baffles to open the inlet 141 and the outlet 142 and controlling the air conditioner 121 to be turned on is performed.

In this step, when the ambient humidity RH0 is greater than the first preset humidity RH1, that is, the humidity in the battery compartment 11 is high and condensate water is easily generated, the inlet 141 and the outlet 142 are opened so that the air conditioner 121 can reduce the humidity in the battery compartment 11.

If the ambient humidity RH0 in the battery compartment 11 is less than or equal to the first preset humidity RH1, S6 of controlling the baffles to close the inlet 141 and the outlet 142, controlling the air conditioner 121 to be turned on, and controlling a battery pack 2 in the battery compartment 11 to start operating is performed.

In this step, the ambient humidity RH0 is less than or equal to the first preset humidity RH1, that is, the humidity in the battery compartment 11 is low and condensate water is not easily generated, and the ambient temperature T in the battery compartment 11 is a temperature suitable for the operation of the battery pack 2. Therefore, the inlet 141 and the outlet 142 can be closed to control the battery pack 2 to start operating. At the same time, the air conditioner 121 can be turned on to prevent damage to the device caused by an excessively high temperature in the device compartment 12.

It should be understood that when the ambient temperature T is higher than or equal to the first preset temperature T1, the air conditioner 121 may cool down the battery compartment 11 and also reduce the humidity in the battery compartment 11. When the ambient temperature T is lower than or equal to the second preset temperature T2, heating up the battery compartment 11 may increase a capability of the air to hold water vapor and reduce a probability of generation of condensate water. Therefore, determining whether the ambient humidity RH0 in the battery compartment 11 meets a requirement only when the ambient temperature T in the battery compartment 11 is lower than the first preset temperature T1 and higher than the second preset temperature T2 can reduce workload of the control component.

Specifically, the standard humidity RH1 is humidity corresponding to the ambient temperature T being a dew point temperature minus a preset value x. That is, the standard humidity RH1 is humidity at which water vapor in the air does not easily condense at the ambient temperature T. The preset value x satisfies 30%≤x≤40%. For example, the preset value x may specifically be 30%, 32%, 35%, 38%, 40%, or the like.

In this embodiment, the preset value x should be not be excessively large or excessively small. If the preset value x is excessively large (e.g., greater than 40%), the calculated standard humidity RH1 may be small, which prolongs operating hours of the air conditioner 121 and increases energy consumption of the energy storage apparatus. If the preset value x is excessively small (e.g., less than 30%), the calculated standard humidity RH1 may be large, leading to a greater probability of generation of condensate water in the battery compartment 11. Therefore, when the preset value x satisfies 30%≤x≤40%, energy consumption of the energy storage apparatus can be effectively reduced while condensate water is easily generated in the battery compartment 11. In addition, the preset value x is preferably 35%.

In a specific embodiment, after the step of controlling the baffles to open the inlet 141 and the outlet 142, the thermal management control method further includes: controlling the drive component to operate.

In this embodiment, by controlling the operation of the drive component, a flow speed of the air between the battery compartment 11 and the device compartment 12 can be increased, thereby improving adjustment efficiency and an adjustment effect of the temperature in the battery compartment 11.

Further, after the step of controlling the baffles to close the inlet 141 and the outlet 142, the thermal management control method further includes: controlling the drive component to stop operating. Energy consumption of the energy storage apparatus can be reduced by controlling the drive component to stop working after the inlet 141 and the outlet 142 are closed.

The above descriptions are only preferred embodiments of the present disclosure and are not intended to limit the present disclosure. For those skilled in the art, the present disclosure may have various modifications and changes. Any modifications, equivalent replacements, improvements, and the like made within the spirit and principles of the present disclosure shall be included in the protection scope of the present disclosure.

1. An energy storage apparatus, comprising:
a box, the box comprising:
a battery compartment provided with a separation portion, the separation portion dividing the battery compartment into an upper compartment and a lower compartment, the separation portion being provided with a communication hole in communication with the upper compartment (112) and the lower compartment;
a device compartment provided with an air conditioner, a first side wall being provided between the battery compartment and the device compartment, the first side wall being provided with an inlet and an outlet, one of the inlet and the outlet being in communication with the upper compartment, and another of the inlet and the outlet being in communication with the lower compartment; and
baffles provided at the inlet and the outlet, wherein the baffles are capable of opening or closing the inlet and the outlet.

2. The energy storage apparatus according to claim 1, wherein at least one of the inlet, the outlet, and the communication hole is provided with a drive component configured to drive air to flow unidirectionally.

3. The energy storage apparatus according to claim 1, wherein along a length direction of the box, a plurality of battery compartments are provided, adjacent battery compartments are in communication with each other, and each of the battery compartments is provided with the separation portion.

4. The energy storage apparatus according to claim 1, wherein along the length direction of the box, the communication hole is provided in the separation portion farthest from the device compartment.

5. The energy storage apparatus according to claim 3, wherein along the length direction of the box, the battery compartment farthest from the device compartment has a second side wall, and a deflector is provided on a side of the second side wall facing the first side wall.

6. The energy storage apparatus according to claim 5, wherein in a direction from the first side wall to the second side wall, the deflector is inclined towards the communication hole.

7. The energy storage apparatus according to claim 6, wherein an angle between the deflector and a horizontal direction is in a range of 5° to 85°.

8. The energy storage apparatus according to claim 3, wherein each of the battery compartments is provided with a mounting rack, and the separation portion is mounted on the mounting rack.

9. The energy storage apparatus according to claim 1, wherein along a height direction of the box, the separation portion is provided at a middle position of the battery compartment.

10. The energy storage apparatus according to claim 8, wherein a battery pack is placed on the mounting rack, and a liquid cooling plate is provided below the battery pack.

11. The energy storage apparatus according to claim 1, wherein a power conversion system and an energy management system control cabinet are placed in the device compartment.

12. The energy storage apparatus according to claim 11, further comprising a high-voltage compartment located at a bottom or top of the battery compartment, wherein a high-voltage box is placed in the high-voltage compartment, the high-voltage box has a high-voltage circuit management module configured to connect the battery pack and the power conversion system.

13. The energy storage apparatus according to claim 12, wherein the high-voltage compartment and the battery compartment are separated by a partition.

14. A thermal management control method applied to the energy storage apparatus according to claim 1, the thermal management control method comprising:
acquiring an ambient temperature T in the battery compartment;
determining whether the ambient temperature T is higher than or equal to a first preset temperature T1;
if the ambient temperature T is higher than or equal to the first preset temperature T1, controlling the baffles to open the inlet and the outlet, and controlling the air conditioner to be turned on;
if the ambient temperature T is lower than the first preset temperature T1, continuously determining whether the ambient temperature T is lower than or equal to a second preset temperature T2; and
if the ambient temperature T is lower than or equal to the second preset temperature T2, controlling the baffles to open the inlet and the outlet, and controlling the air conditioner to be turned off.

15. The thermal management control method according to claim 14, wherein when it is determined that the ambient temperature T is lower than the first preset temperature T1 and higher than the second preset temperature T2, the thermal management control method further comprises:
acquiring an ambient humidity RH0 in the battery compartment, and calculating a standard humidity RH1 according to the ambient temperature T;
determining whether the ambient humidity RH0 in the battery compartment is less than or equal to first preset humidity RH1;
if the ambient humidity RH0 in the battery compartment is less than or equal to the first preset humidity RH1, controlling the baffles to close the inlet and the outlet, controlling the air conditioner to be turned on, and controlling a battery pack in the battery compartment to operate; and
if the ambient humidity RH0 in the battery compartment is greater than the first preset humidity RH1, controlling the baffles to open the inlet (141) and the outlet, and controlling the air conditioner to be turned on.

16. The thermal management control method according to claim 15, wherein the standard humidity RH1 is a humidity corresponding to the ambient temperature T being a dew point temperature minus a preset value x.

17. The thermal management control method according to claim 14, wherein the preset value x satisfies 30%≤x≤40%.

18. The thermal management control method according to claim 15, wherein at least one of the inlet, the outlet, and the communication hole is provided with a drive component;
after controlling the baffles to open the inlet and the outlet, the thermal management control method further comprises: controlling the drive component to operate; and
after controlling the baffles to close the inlet and the outlet, the thermal management control method further comprises: controlling the drive component to stop operating.

19. The thermal management control method according to claim 14, wherein the first preset temperature T1 is selected in a range of 25° C. to 30° C.

20. The thermal management control method according to claim 14, wherein the second preset temperature T2 is selected in a range of 20° C. to 25° C.
